(19) United States
(12) Patent Application Publication
(10) Pub. No.: US 2009/0217362 A1
(43) Pub. Date: Aug. 27, 2009

(54) SELECTIVELY PROVISIONING CLIENTS WITH DIGITAL IDENTITY REPRESENTATIONS

(75) Inventors: Arun K. Nanda, Sammamish, WA (US); Hervey Wilson, Bellevue, WA (US); Dan Guberman, Bellevue, WA (US); Vijay K. Gajjala, Sammamish, WA (US); Raman Chikkamagalur, Sammamish, WA (US); Oren Melzer, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/432,606

(22) Filed: Apr. 29, 2009

Related U.S. Application Data
(63) Continuation-in-part of application No. 11/856,636, filed on Sep. 17, 2007.
Application No. 11/856,636 is a continuation-in-part of application No. 11/856,617, filed on Sep. 17, 2007.
(60) Provisional application No. 60/885,598, filed on Jan. 18, 2007.

(51) Int. Cl. G06F 21/22; G06F 15/16

(52) U.S. Cl. 726/5; 726/12; 709/203

(57) ABSTRACT

A server provisions a client with digital identity representations such as information cards. A provisioning request to the server includes filtering parameters. The server assembles a provisioning response containing cards that satisfy the filtering parameters, and transmits the response to a client, possibly by way of a proxy. The provisioning response may include provisioning state information to help a server determine in subsequent exchanges which cards are already present on the client. A client may keep track the source of information cards and discard cards which a server has discarded. A proxy may make the provisioning request on behalf of a client, providing the server with the proxy's own authentication and with a copy of the request from the client to the proxy.

### RELATED APPLICATIONS

This application is related to U.S. patent application Ser. No. 11/856,636 filed Sep. 17, 2007, which claims priority in turn to U.S. provisional application No. 60/885,598 filed Jan. 18, 2007. This application is also related to U.S. patent application Ser. No. 11/856,617 filed Sep. 17, 2007. This application is also related to U.S. patent application Ser. No. 11/361,281 filed Feb. 24, 2006. Each of these applications is incorporated herein in their entirety.

### BACKGROUND

Digital identities provide a set of claims about an entity, and in particular provide claims about an individual person. The claims may assert data such as a name, address, age, organizational role, account number, and/or other characteristics of a person. Digital identities may be implemented with various features and constraints, using for example approaches discussed in connection with terms such as “digital identity representation”, “information card”, “i-card”, and “infocard”. In general, a digital identity is created by an entity known as an “issuer” or an “identity provider” for a person who is known as the “subject” or “principal” of the identity. Digital identities can be provided to one or more “relying parties” for purposes such as establishing or confirming the subject's identity, age, account number, role, access rights, and/or other characteristics asserted by claim(s) of the digital identity.

### SUMMARY

Provisioning a client computer with digital identities such as information cards can be done through a manual process. For example, a file can be used as a container for a card, with the contents of the file digitally signed. However, such manual provisioning is time-consuming and may be error-prone.

With some embodiments discussed herein, however, a server automatically provisions a client with digital identity representation(s), such as information cards that represent aspects of a natural person's identity. The server receives a provisioning request for digital identity representations. The provisioning request includes at least one client-specified filtering parameter associated with at least one digital identity representation field. For instance, filtering parameters may specify an identification of an issuer of information cards, an organizational role of a natural person, an account number of the natural person, an age range, and so on. The server automatically assembles a provisioning response containing at least one digital identity representation that satisfies the filtering parameter(s) of the provisioning request, and transmits the provisioning response to the client over a computer network, possibly by way of a proxy.

In some embodiments, the provisioning response also includes client provisioning state information for storage at the client. The provisioning state information includes version indication(s) of the digital identity representation(s) being provided to the client. The provisioning state information may be included in a subsequent provisioning request to help a server determine which digital identity representation(s) are already present on the client. For example, a provisioning response may include a full copy of a first information card not yet known to be present at the client, and a reference to a second card that is already present instead of including a full copy of the second information card.

In some embodiments, a client keeps track of which information cards come from which servers, and follows a given server's lead by discarding information cards which that server has discarded. The server can expressly update the client when the server discards cards. Alternately, the client may deduce that a card has been discarded when the client does not receive the card (either as a full copy or as a reference) from the server even though the card was received from the server earlier pursuant to the same filtering parameter(s).

In some embodiments, a provisioning request includes a proxy identifier for a proxy making the provisioning request on behalf of a client. For instance, the provisioning request may contain a proxy-server provisioning request from a proxy to a server inside a firewall, and a client-proxy provisioning request from a client outside a firewall to the proxy, including an indication that the proxy has accepted the client as authorized based on a particular client authorization basis such as a password, digital secret, or digital certificate.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a client computer system and a server computer system each having a processor and a memory, digital identity representations, and other items in an operating environment which may be present on multiple network nodes, and also illustrating configured storage medium embodiments;

FIG. 2 is a block diagram further illustrating a server configured for provisioning information cards and/or other digital identity representations in an example architecture;

FIG. 3 is a flow chart illustrating steps of some method and configured storage medium embodiments which may be performed by a server;

FIG. 4 is a flow chart illustrating steps of some method and configured storage medium embodiments which may be performed by a client;

FIG. 5 is a data flow diagram illustrating provisioning information cards and/or other digital identity representations in an example architecture having direct communication between a client and a provisioning server; and

FIG. 6 is a data flow diagram illustrating provisioning information cards and/or other digital identity representations in an example architecture having indirect communication between a client and a provisioning server by way of a trusted proxy.

### DETAILED DESCRIPTION

### Overview

Familiar approaches to provisioning a subject's client computer with information cards use a .crd file format. Information card format is described in the Identity Selector Interoperability Profile v1.5 specification. To provision a subject's client the subject, or an administrator, manually enters commands in order to download an information card from a card issuer and install it onto the client. Such provisioning approaches have several disadvantages. First, there is no mechanism to limit and focus the set of information cards requested, e.g., to select cards based on filtering criteria. Second, the information cards are individually packaged and signed as files, and do not rely on channel security. Third, there is no mechanism for provisioning cards through a trusted intermediary on behalf of an end user. Fourth, there is no mechanism for a provisioning server to version the existing state of the cards and then choose to not create a new card copy if the client already has the up to date version.

Some embodiments provided herein provide or use a digital identity representation provisioning protocol, including client provisioning protocol request and response formats which support filter parameters in the request to allow fine-grained selection of information cards to be provisioned. A client can make a request for cards to a provisioning service, and the provisioning service can respond with an appropriate collection of information cards for that client. The request for cards by the client is specified in the form of a query to a server using filtering parameters that can be evaluated by the server. The server responds with a set of cards that satisfy the query and are suitable for the client. The protocol allows the client to optionally include data about client-side state, to support server optimizations to reduce network traffic and conserve network bandwidth. Server throughput may also improve, by reducing instances of creation of a full information card and hence reducing server CPU usage and/or latency caused by database queries. The protocol also allows a trusted intermediary to request the cards on behalf of the client in a way that allows the client's identity to be preserved and conveyed to the server. Some embodiments facilitate automation of information card provisioning, leading to a more streamlined user experience in contrast with familiar manual approaches.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. In the event of an irresolvable conflict between a term's meaning as used expressly herein and the term's meaning as used in an incorporated document, the express meaning herein governs. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Card” used alone refers to an “information card”, which is a type of digital identity representation. Other types of digital identity representation are also provisionable with the protocol(s) describe herein, e.g., digital identity representations which do not convey the same claims and/or use the same file/schema formats as information cards.

Throughout this document, use of the optional plural “(s)” means that one or more of the indicated feature is present. For example, “card(s)” means “one or more cards” or equivalently “at least one card”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

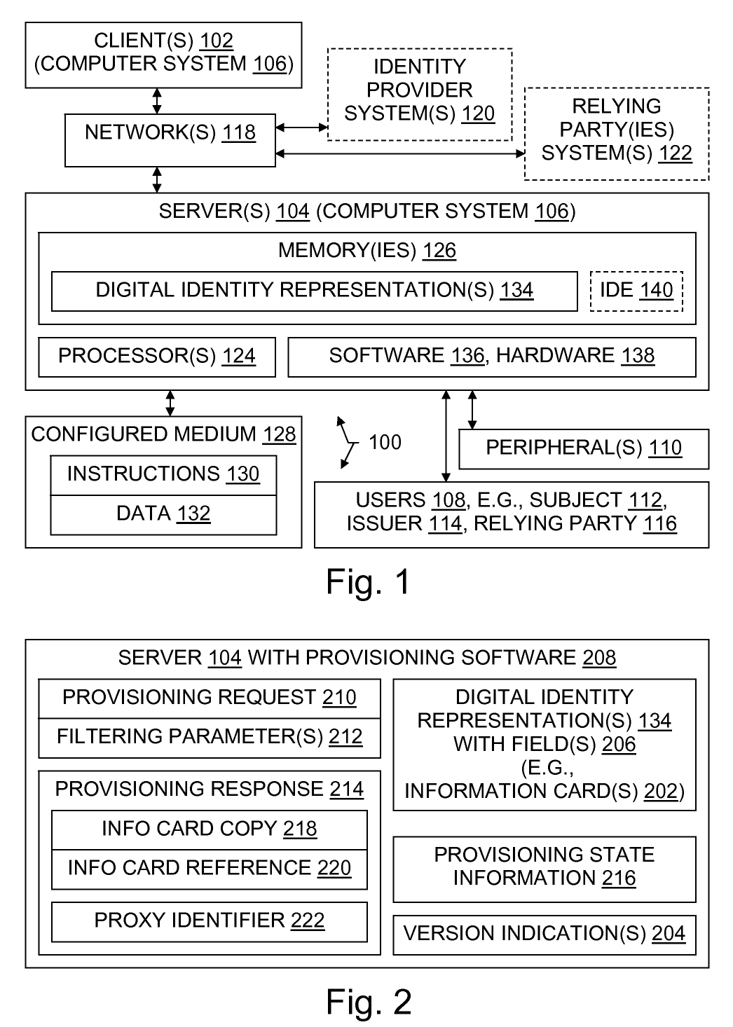

With reference to FIG. 1, an operating environment 100 for an embodiment may include a client 102 and a server 104, each of which is an example of a computer system 106. A particular computer system 106 may be a multiprocessor computer system, or not. An operating environment may include one or more machines in a given computer system, which may be clustered, client-server networked, and/or peer-to-peer networked.

Human users 108 may interact with a computer system 106 by using displays, keyboards, and other peripherals 110. Storage devices and/or networking devices may be considered peripheral equipment in some embodiments. System administrators, developers, engineers, and end-users are each a particular type of user 108. In terms of digital identity management, a subject 112 (a.k.a. principal), an issuer 114 (a.k.a. identity provider), and a relying party 116 are each also an example of a user 108. Automated agents acting on behalf of one or more people may also be users 108.

Other computer systems not necessarily shown in FIG. 1 may interact with the computer system(s) 106 or with another system embodiment using one or more connections to one or more networks 118 via network interface equipment, for example. In particular, identity provider system(s) 120 and/or relying party system(s) 122 may interact with the client(s) 102 and/or the server(s) 104. Although client(s) 102 and server(s) 104 are shown in their own respective blocks in FIG. 1 for emphasis, in some environments the client(s) 102 and/or the server(s) 104 are controlled by or otherwise within the scope of identity provider system(s) 120 and/or relying party system(s) 122.

Each computer system 106 includes at least one logical processor 124, and one or more memories 126. The memories 126 may be volatile, non-volatile, fixed in place, removable, magnetic, optical, and/or of other types. In particular, a configured medium 128 such as a CD, DVD, memory stick, or other removable non-volatile memory medium may become functionally part of the computer system when inserted or otherwise installed, making its content accessible for use by processor 124. The removable configured medium 128 is an example of a memory 126. Other examples of memory 126 include built-in RAM, ROM, hard disks, and other storage devices which are not readily removable by users 108.

The medium 128 is configured with instructions 130 that are executable by a processor 124; “executable” is used in a broad sense herein to include machine code, interpretable code, and code that runs on a virtual machine, for example. The medium 128 is also configured with data 132 which is created, modified, referenced, and/or otherwise used by execution of the instructions 130. The instructions 130 and the data 132 configure the memory 126/medium 128 in which they reside; when that memory is a functional part of a given computer system, the instructions 130 and data 132 also configure that computer system. In some embodiments, a portion of the data 132 is representative of real-world items such as a natural person's physical characteristics, addresses, physical measurements, images, and so forth. Such data is also transformed by as discussed herein, e.g., by filtering, versioning, comparing, determining, copying, referencing, displaying, creating, modifying, loading, and/or other operations.

Memories 126 may be of different physical types. A digital identity representation 134, identity applications and other software 136, and other items shown in the Figures may reside partially or entirely within one or more memories 126, thereby configuring those memories. An operating environment may also include other hardware 138, such as displays, buses, power supplies, and accelerators, for instance.

A given operating environment 100 may include an Integrated Development Environment (IDE) 140 which provides a developer with a set of coordinated software development tools. In particular, some of the suitable operating environments for some embodiments include or help create a Microsoft® Visual Studio® development environment (marks of Microsoft Corporation) configured to support program development. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development per se that use digital identity representations.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 further illustrates an architecture which is suitable for use with some embodiments. In some embodiments, a server 104 computer system 106 has hardware including a logical processor 124 and a memory 126 configured by circuitry, firmware, and/or software to be in operable communication with the logical processor. A collection of digital identity representations 134, such as information cards 202, configures a portion of the memory 126.

In some embodiments, the role of a client 102 in provisioning cards 202 is played by a first peer node of a peer-to-peer network, and the role of a server 104 in provisioning cards is played by a second peer node of the peer-to-peer network. A given system 106 may play the role of client 102 in one provisioning exchange, and then play the role of server 104 in another provisioning exchange. The terms “client” and “server” should accordingly be understood to refer herein to roles played by systems in card provisioning.

In some embodiments, the digital identity representations 134 have associated version indication(s) 204. Version indications may be implemented as timestamps or sequence numbers, for example. Version indications may be associated by being embedded in a struct or record that also includes fields 206 of data which represent claims (in the digital identity sense, not the general patent law sense) of a digital identity representation. Version indications may also be associated by using pointers, handles, indexes, GUIDs, or other links. A given version indication may be associated with one or more digital identity representations, depending on the implementation and current configuration.

In some embodiments, provisioning software 208 configures a portion of the server 104 memory 126, a portion of the client 102 memory 126, or both. On the server 104, the provisioning software may embody code to automatically receive via network 118 transmission a provisioning request 210 for digital identity representations such as information cards 202. The provisioning request includes filtering parameters 212 associated with digital identity information card field(s) to indicate which cards are desired. The server provisioning software may automatically identify within the collection any digital identity information cards which satisfy the filtering parameter(s), and create a provisioning response 214 accordingly.

Of course, in some situations and product configurations, a request for provisioning may include no filtering parameters and/or equivalently may include only null values for filtering parameters. But this possibility does not prevent one from focusing on the alternates contemplated here, in which non-null filtering parameters are present in a provisioning request and hence are capable of limiting which cards 202 will be provided in response to the request.

In some situations, for example, the provisioning response 214 contains at least one digital identity information card 202 which satisfies at least one of the following filtering parameters 212: an identification of an issuer 114 of information cards, an organizational role of the natural person who is the subject 112 of the information card, an account number of the natural person who is the subject 112 of the information card. Digital identity representations 134 provisioned as described herein may also contain additional or different fields.

In some embodiments, the server sends provisioning state information 216 with the provisioning response. The provisioning state information can then be supplied to the server with a later provisioning request, to let the server know which information cards the client has already received. Cards which have not yet been sent to the client, at least not in their current version, can be included in the provisioning response in the form of an information card copy 218, whereas cards that have already been sent to the client can be included in the response in smaller form as an information card reference 220, in order to conserve network bandwidth and system processing capacity. A digital identity representation reference 220 may be implemented by pointers, handles, indexes, GUIDs, or other links that allow a client to locally access a copy 218 of the card 202. In some embodiments, provisioning state information may name, include a copy of, reference, and/or otherwise indicate both a client and a set of the client's digital identity information cards.

In some embodiments, a client 102 sends the provisioning request to the server 104 by way of a proxy (shown, e.g., as trusted proxy 602 in FIG. 6). Accordingly, such an overall system includes a client and/or proxy configured with a client-proxy provisioning request 210 for digital identity information cards, and a proxy and/or server configured with a corresponding proxy-server provisioning request 210. In some configurations, the server is inside a firewall 604, and the client is outside the firewall. The server memory may also be configured with a copy of a password-usage indication, certificate, and/or other client authorization basis 326 for authenticating the client to the proxy and with a proxy authorization basis 324 for authenticating the proxy to the server, so that the server knows the identity and authorization basis of both the client and the proxy. In some embodiments, the overall system includes a proxy identifier 222 which identifies the proxy to the server 104. A proxy identifier 222 may be implemented using an IP address, a MAC address or another hardware address, a name-value pair, a digital certificate, and/or other proxy identifications already familiar for use in contexts other than the card provisioning described herein.

In some embodiments, provisioning software 208 configures a portion of the client 102 memory 126 with code to automatically track origin location(s) of digital identity information cards received at the client. For instance, a server IP address, domain name, digital certificate ID, and/or other server identification may be stored with or otherwise associated with each card 202 or group of cards, to indicate the origin of the card(s). The client's provisioning software 208 also automatically compares a first set of digital identity information card(s) which were received from a particular origin location and which satisfy certain filtering parameter(s) to a second set of digital identity information card(s) which were received from the same origin location and which satisfy the same filtering parameter(s). The software can then automatically identify digital identity information card(s) which belong to the first set but not the second set, namely, cards 202 which the server in question sent previously in response to a query using those filtering parameters but did not include in a more recent response 214 seeking cards that match the same filtering criteria. The client may then deduce that the server discarded the omitted cards after sending the first response, and that the cards are therefore no longer valid and/or no longer needed. Accordingly, the client may automatically discard each digital identity information card which belongs to the first set (the set sent in an earlier response) but not the second set (sent in the later response).

In some embodiments peripherals 110 such as human user I/O devices (screen, keyboard, mouse, tablet, microphone, speaker, motion sensor, etc.) will be present in operable communication with one or more processors 124 and memory 126. However, an embodiment may also be deeply embedded in a system, such that no human user 108 interacts directly with the embodiment. Software processes may be users 108.

In some embodiments, the system includes multiple computers connected by a network. Networking interface equipment can provide access to networks 118, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Methods

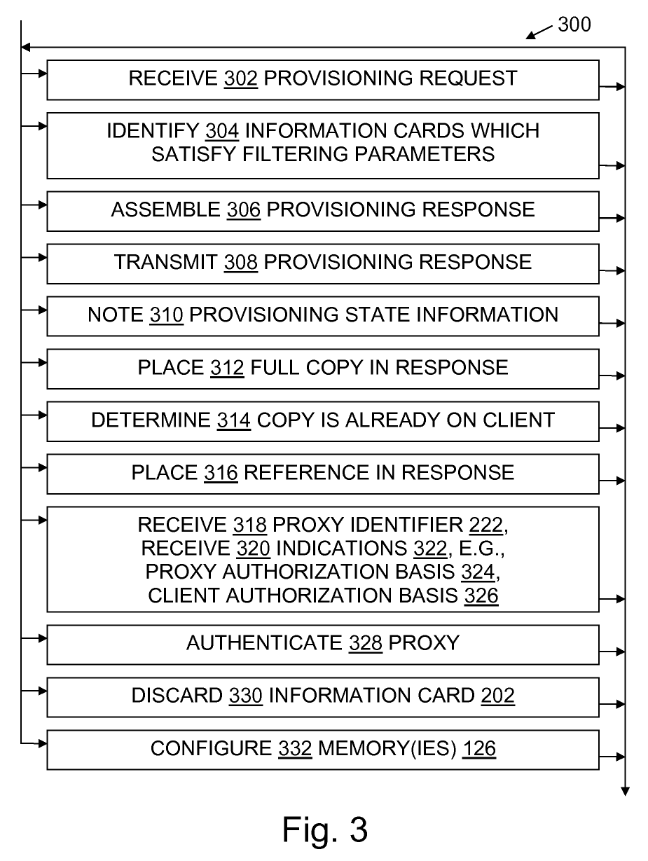

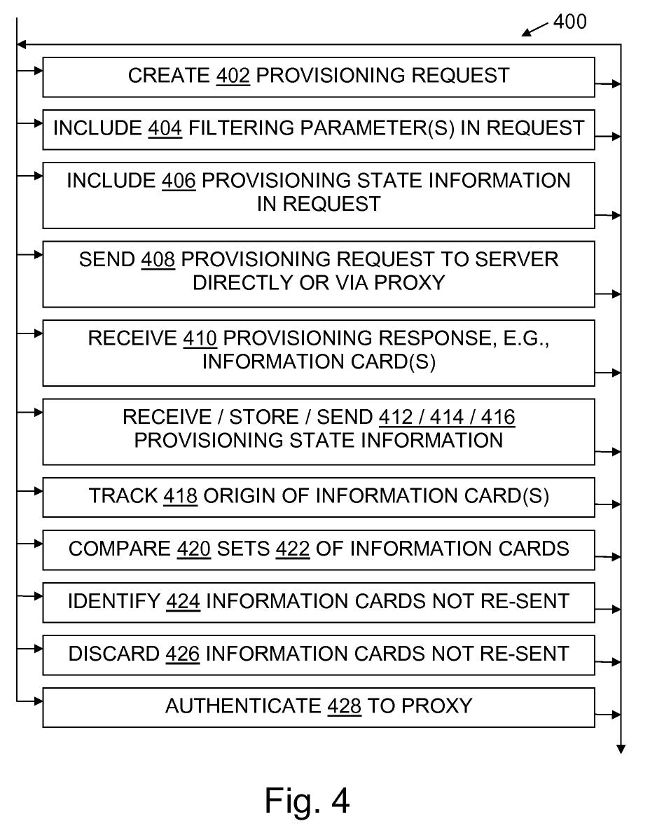

FIGS. 3 and 4 each illustrate some method embodiments in respective flowcharts 300 and 400. Methods shown in the Figures may be performed in some embodiments automatically, e.g., by provisioning software 208 on a client 102 and/or provisioning software 208 on a server 104 operating under control of a script requiring little or no user input. Methods may also be performed in part automatically and in part manually unless otherwise indicated. In a given embodiment zero or more illustrated steps of a method may be repeated, perhaps with different parameters or data to operate on. Steps in an embodiment may also be done in a different order than the top-to-bottom order that is laid out in the Figures, and a given embodiment may include steps from FIG. 3, from FIG. 4, or from both Figures. Steps may be performed serially, in a partially overlapping manner, or fully in parallel. The order in which flowchart 300 and/or flowchart 400 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flows, provided that the method performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

FIG. 3 illustrates steps to be performed by a server 104.

During a provisioning request receiving step 302, an embodiment receives a digital identity representation provisioning request 210, either from a client directly or from a proxy on behalf of a client. Step 302 may be accomplished using network transfer of files, XML, or another mechanism, for example. In some embodiments and configurations, filtering parameters 212 for use in a given provisioning request 210 are received in the same file/transmission session/transaction as other parts of the provisioning request 210, whereas in other embodiments and/or other configurations, multiple files/transmission sessions/transactions are used to receive a provisioning request which is completed and ready to be acted upon.

During an identifying step 304, an embodiment identifies information cards (or other digital identity representations, depending on the embodiment) which satisfy filtering parameters received 302 with a provisioning request. Step 304 may be accomplished using string matching, enumeration value comparison, numeric comparison, indexing, database search, and/or another mechanism, for example.

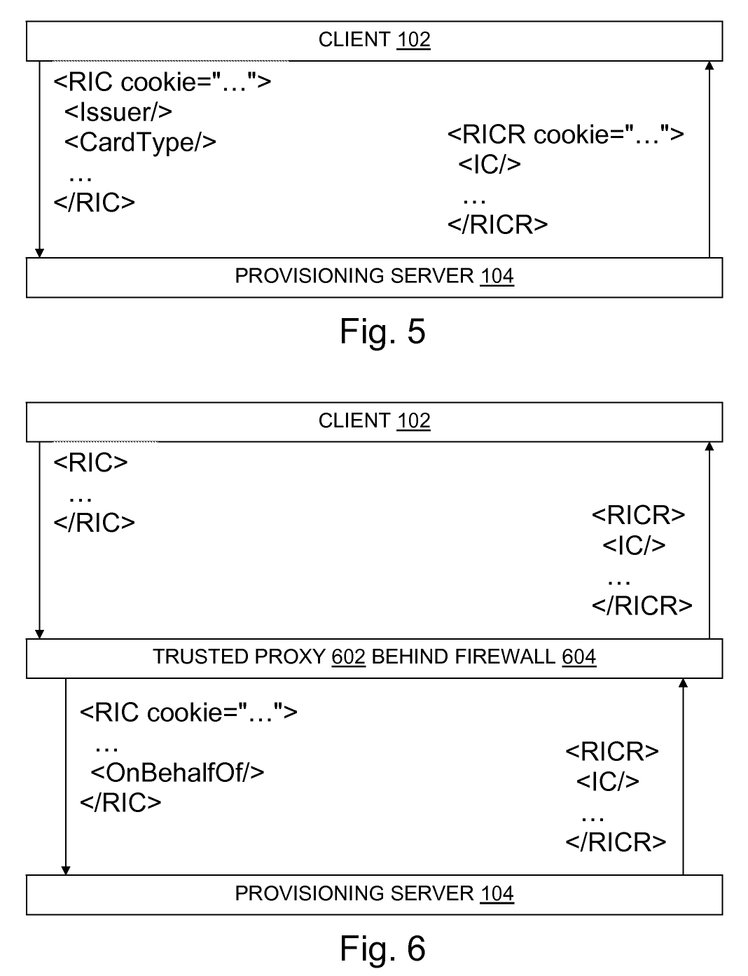

During a provisioning response assembling step 306, an embodiment assembles a response to a provisioning request. Step 306 may include operations such as copying information cards into a buffer, copying information card references 220 into the buffer, placing a timestamp and/or other version indication 204 in the buffer (possibly in the format used by cookies), and digitally signing the buffer contents, for example. Step 306 may also include placing in a memory buffer an XML record using specified tags such as an RICR tag, for example, as illustrated in FIGS. 5 and 6. Different embodiments may use different tag keywords.

During a provisioning response transmitting step 308, an embodiment transmits a provisioning response onto a computer network 118, toward a client either directly or via a proxy.

During a state noting step 310, an embodiment notes provisioning state information 216 provided with a provisioning request. The provisioning state information may list information card(s) with associated version indication(s) to allow the server to avoid re-sending information cards that are already present on the client in their most current version. The same information card reference 220 data format(s) used in a provisioning response can be used in the provisioning state information 216.

During a copy placing step 312, an embodiment places a full copy 218 (as opposed to a mere reference 220) of an information card or other digital identity representation in a provisioning response while assembling the response. A full copy would be placed, for instance, when the server cannot determine 314 from the provisioning state information or from the server's own internal records whether a current copy of the information card in question is already on the client.

During a determining step 314, an embodiment determines from provisioning state information and/or from a server's own internal records (e.g., transmission log) whether a copy of a particular information card already exists on a client. For example, if the information card satisfies the provisioning request filter parameters but has already been sent to the client in response to a different request, then the determining step may find the information card's handle or GUID in provisioning state information that arrived with the provisioning request. Accordingly, the server may place 316 the GUID in a response 214 that is being assembled 306, instead of placing 312 a full copy of the card in the response.

During a reference placing step 316, an embodiment places in provisioning response 214 a GUID, handle, or other reference 220 to an information card or other digital identify representation 134. For example, the references may be copied into a memory buffer as the provisioning response is being assembled 306.

During a proxy identifier receiving step 318, an embodiment receives a proxy identifier 222 identifying a proxy which is requesting information cards. Proxy identifier receiving step 318 may be accomplished using networks 118 and network mechanisms such as XML, HTTPS, and the like, similar to other receiving steps 302, 320, 410, 412.

During an authorization indication receiving step 320, an embodiment receives an indication of the identity and/or other authorization basis/status of a system 106 that is involved in a provisioning request. For example, an embodiment may receive a proxy authorization basis 324 such as a proxy's digital certificate, password, digital secret, or the like. Similarly, an embodiment may receive a client authorization basis 326 such as a client's digital certificate, a proxy's assertion that the client's password was acceptable, a digital secret, or the like.

During a proxy authenticating step 328, an embodiment authenticates a proxy. For instance, a server 104 may accept a proxy's digital certificate. If the proxy's credentials are acceptable but the client's are not, the server may refuse to authenticate the proxy for the requested provisioning exchange, even if the proxy is authenticated by the server for provisioning exchanges with other clients.

During a card discarding step 330, an embodiment discards an information card or other digital identity representation, e.g., by marking the card invalid, by removing it from a local card store, or by other actions. A card may be discarded in favor of a more recent version of the card, for example, and/or to follow the lead of a server which has discarded the card.

During a memory configuring step 332, a memory 126 is configured by a provisioning request 210, a provisioning response 214, or otherwise in connection with digital identity representation (e.g., information card) provisioning as discussed herein.

Turning now to FIG. 4, during a provisioning request creating step 402, a client embodiment creates a provisioning request 210. Step 402 may be accomplished in part by placing in a memory buffer an XML record using specified tags such as an RIC tag, for example, as illustrated in FIGS. 5 and 6. Different embodiments may use different tag keywords. A provisioning creation step 402 may also include placing in a memory buffer any other item a server or a proxy might expect or process, including for instance filtering parameter(s) 212, provisioning state information 216, and/or an authorization basis 324 and/or 326.

During a filtering parameters including step 404, an embodiment places one or more filtering parameters 212 in a provisioning request 210. Filtering parameters may be specified as enumeration values, numeric values, numeric ranges, strings with required characters and/or wildcards and/or other lexical constraints, and/or other constraints on the value of digital identity representation field(s) 206.

During a state information including step 406, an embodiment places provisioning state information 216 in a provisioning request 210, e.g., by placing a copy of the provisioning state information in a memory buffer.

During a provisioning response receiving step 410, an embodiment receives a provisioning response transmitted 308 over a network 118.

During a provisioning state information receiving step 412, an embodiment receives provisioning state information 216 transmitted 308 over a network 118.

During a provisioning state information storing step 414, an embodiment stores received provisioning state information 216. The provisioning state information may be stored 414 on hard disk or in RAM, for instance, after being received.

During a provisioning state information sending step 416, an embodiment sends previously received provisioning state information 216 over a network 118, so a server has the option of noting 310 that provisioning state information.

During a card origin tracking step 418, an embodiment tracks the origin of information card(s) (or other digital identity representations) received 410 over a network. For instance, a client may record locally the IP address, digital certificate, domain, and/or other identifier of the server(s) and/or proxy(ies) from which an information card 202 is transmitted 308 to the client. Likewise, a proxy may record locally the address or other identifier of a server from which an information card 202 is transmitted 308 to the proxy.

During a card sets comparing step 420, an embodiment compares a first set 422 of digital identity information card(s) which were received from a particular origin location (e.g., same server/same proxy) and which satisfy certain filtering parameter(s) to a second set 422 of digital identity information card(s) which were received from the same origin location and which satisfy the same filtering parameter(s) as the first set of cards. Card sets may be compared in some embodiments by comparing lists or other sets 422 of card references 220.

During an omitted card(s) identifying step 424, an embodiment identifies card(s) which were not re-sent from a given origin location. That is, step 424 identifies cards that belong to the first set discussed above in regard to step 420 but not the second set. Such cards 202 are omitted in the sense that the server in question sent the cards previously in response to a query using certain filtering parameters but did not include the omitted cards in a more recent response 214 seeking cards that match the same filtering criteria. Omitted cards may be identified by their corresponding references 220, for example.

During a card discarding step 426, an embodiment discards information cards. In particular, a client may discard 426 omitted cards which were identified 424 as not re-sent by a server, thereby acting on an assumption that the server discarded the omitted cards and hence the omitted cards are no longer valid and/or no longer needed in the system.

During a client authenticating step 428, an embodiment authenticates a client to a proxy, e.g., by submitting a password or a digital certificate that is acceptable to the proxy. A client may also authenticate 428 directly to a server.

The foregoing steps and their interrelationships are discussed in greater detail below, in connection with various embodiments.

Some embodiments provide a method performed by a server 104 for provisioning a client 102 with at least one digital identity representation 134 which represents aspects of a natural person's identity. The method includes the server receiving 302 a provisioning request 210 for digital identity representations. The provisioning request 210 includes at least one filtering parameter 212 associated with at least one digital identity representation field 206. For example, one or more of the following may be received as a filtering parameter: an organizational role of the natural person, an account number of the natural person. The server automatically assembles 306 a provisioning response containing at least one digital identity representation 134—each digital identity representation in the provisioning response satisfies the filtering parameter(s) of the provisioning request. In particular, the provisioning response may include multiple digital identity representations in the form of multiple information cards. The server then transmits 308 the provisioning response onto a network 118.

In some embodiments, the assembling step 306 includes placing 312 at least one full copy of an information card in the provisioning response. In some embodiments, the assembling step 306 includes determining 314 that a copy of an information card already present on the client is current, and placing 316 a reference to that copy in the provisioning response instead of placing a full copy of the information card in the provisioning response.

In some embodiments, the provisioning response 214 includes client provisioning state information 216 for storage at the client. The provisioning state information includes one or more version indications 204 of the digital identity representation(s) of the provisioning response. In some embodiments, the provisioning request 210 includes client provisioning state information 216 previously sent to the client by the server.

In some embodiments, the provisioning request 210 includes a proxy identifier 222 which identifies a proxy purporting to make the provisioning request on behalf of the client. One says “purporting” to acknowledge the possibility that a proxy may be used in an attempt to obtain information cards without a corresponding provisioning request from a client to the proxy. In some embodiments, the server receives 320 an indication 322 that a proxy has accepted the client as authorized based on a client authorization basis 326, and the server also receives a request to accept the proxy as authorized based on a proxy authorization basis 324. For example, in one of many possible situations the client authorization basis includes a password, and the proxy authorization basis includes a digital certificate.

Some embodiments provide a method performed by a client 102 for at least attempting to obtain at least one digital identity information card 202 from at least one server 104. The method includes the client creating 402 a provisioning request 210 for digital identity information cards. The provisioning request includes at least one filtering parameter 212 associated with at least one digital identity information card field 206 representing an aspect of a natural person's identity. That is, at least one filtering parameter is present and is also non-null. The client then sends 408 the provisioning request toward a server on a computer network; one says “toward” because the immediate destination could be a proxy rather than the server.

In some embodiments and some situations, the client receives 410 a provisioning response containing at least one digital identity information card 202 which satisfies the filtering parameter(s) of the provisioning request. In other situations, no cards satisfy the filtering parameters, and the client is notified as much by the server.

In some embodiments, the client automatically tracks 418 server names and/or other origin location(s) of digital identity information card(s) received at the client. The client automatically compares 420 a first set 422 of digital identity information card(s) which were received from a particular origin location and which satisfy certain filtering parameter(s) to a second set 422 of digital identity information card(s) which were received from the same origin location and which satisfy the same filtering parameter(s). The client automatically identifies 424 digital identity information card(s) which belong to the first set but not the second set, that is, cards which were not re-sent from the same server pursuant to the same filtering parameters. The client discards 426 digital identity information card(s) which were not re-sent, namely, cards 202 belonging to the first set but not the second set.

In some embodiments, the client receives 412 provisioning state information in response to a provisioning request, stores 414 the provisioning state information locally, e.g., as a cookie on a hard disk, and then sends 416 the provisioning state information with a subsequent provisioning request.

Configured Media

Some embodiments include a configured computer-readable storage medium 128, which is an example of a memory 126. Memory 126 may include disks (magnetic, optical, or otherwise), RAM, EEPROMS or other ROMs, and/or other configurable memory. The storage medium which is configured may be in particular a removable storage medium 128 such as a CD, DVD, or flash memory. A general-purpose memory 126, which may be removable or not, and may be volatile or not, can be configured into an embodiment using items such as provisioning requests 210, provisioning responses 214, and provisioning software 208, in the form of data 132 and instructions 130, read from a removable medium 128 and/or another source such as a network connection, to form a configured medium. The configured memory 126 is capable of causing a computer system to perform method steps for digital identity representation provisioning as disclosed herein. FIGS. 1 through 4 thus help illustrate configured storage media embodiments and method embodiments, as well as system and method embodiments. In particular, any of the method steps illustrated in FIG. 3 and/or FIG. 4, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Some embodiments may be suitable for inclusion in a Microsoft® Windows CardSpace® environment.

In some embodiments, a solution provisions information cards 202 over an underlying channel using HTTP (Hypertext Transfer Protocol) and SOAP (Simple Object Access Protocol). The provisioning protocol of the embodiment defines messages that are exchanged between the client 102 and the server 104.

In this particular implementation, as illustrated in FIG. 5, a client sends 408 a RequestInformationCard (RIC) request 210 with filtering parameters 212 that relate to fields 206 in the card 202. The client can optionally send 408 client-side state information 216, e.g., in a “cookie”-like data format. The server receives 302 the request, and assembles 306 a set of information cards based on the filtering parameters. The server can also choose not to send the full InformationCard (IC) structure, sending instead only the card's reference 220 if the version of the card on the client is up to date. The server responds to the request by transmitting 308 a RequestInformationCardsResponse (RICR) element that contains the provisioned cards or card references. The server can optionally transmit 308 a “cookie”-like data structure of provisioning state information for the client to keep state locally.

When the provisioning is performed via an intermediary, an additional structure element—OnBehalfOf—is used to send a user identifier. This approach can be used to request cards on behalf of the user client 102 via a trusted proxy 602, as illustrated in FIG. 6. When the proxy makes the provisioning request on behalf of a client, the proxy provides the server 104 with the proxy's own authentication and also with a copy of the original request 210 from the client to the proxy.

### CONCLUSION

Although particular embodiments are expressly illustrated and described herein as methods, as configured media, or as systems, it will be appreciated that discussion of one type of embodiment also generally extends to other embodiment types. For instance, the descriptions of methods in connection with FIGS. 3 and 4 also help describe configured media, and help describe the operation of systems and manufactures like those discussed in connection with other Figures. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A method performed by a server for provisioning a client with at least one digital identity representation which represents aspects of a natural person's identity, the method comprising the steps of the server:
receiving a provisioning request for digital identity representations, the provisioning request including at least one filtering parameter associated with at least one digital identity representation field;
automatically assembling a provisioning response containing at least one digital identity representation, wherein each digital identity representation in the provisioning response satisfies the filtering parameter(s) of the provisioning request; and
transmitting the provisioning response onto a computer network.

2. The method of claim 1, wherein the provisioning response also includes client provisioning state information for storage at the client, the provisioning state information including version indication(s) of the digital identity representation(s) of the provisioning response.

3. The method of claim 1, wherein the provisioning request also includes client provisioning state information.

4. The method of claim 1, wherein the provisioning response includes multiple digital identity representations in the form of multiple information cards.

5. The method of claim 1, wherein the assembling step includes placing at least one full copy of an information card in the provisioning response.

6. The method of claim 1, wherein the assembling step includes determining that a copy of an information card already present on the client is current, and placing a reference to that copy in the provisioning response instead of placing a full copy of the information card in the provisioning response.

7. The method of claim 1, wherein the provisioning request also includes a proxy identifier which identifies a proxy purporting to make the provisioning request on behalf of the client.

8. The method of claim 1, wherein at least one of the following is received as a filtering parameter: an organizational role of the natural person, an account number of the natural person.

9. The method of claim 1, wherein the method further comprises:
the server receiving an indication that a proxy has accepted the client as authorized based on a client authorization basis; and
the server receiving a request to accept the proxy as authorized based on a proxy authorization basis.

10. The method of claim 9, wherein the client authorization basis comprises at least one of: a password, a digital certificate; and wherein the proxy authorization basis comprises a digital certificate.

11. A computer-readable medium configured with data and instructions for causing a client to perform a method for at least attempting to obtain at least one digital identity information card from at least one server, the method comprising the steps of the client:
creating a provisioning request for digital identity information cards, the provisioning request including at least one filtering parameter associated with at least one digital identity information card field representing an aspect of a natural person's identity; and
sending the provisioning request on a computer network.

12. The configured medium of claim 11, further comprising the client receiving a provisioning response containing at least one digital identity information card which satisfies the filtering parameter(s) of the provisioning request.

13. The configured medium of claim 11, wherein the method further comprises the client:
automatically tracking origin location(s) of digital identity information card(s) received at the client;
automatically comparing a first set of digital identity information card(s) which were received from a particular origin location and which satisfy certain filtering parameter(s) to a second set of digital identity information card(s) which were received from the same origin location and which satisfy the same filtering parameter(s); and
automatically identifying digital identity information card(s) which belong to the first set but not the second set.

14. The configured medium of claim 13, further comprising the client discarding at least one digital identity information card which belongs to the first set but not the second set.

15. The configured medium of claim 11, further comprising the client receiving provisioning state information in response to the provisioning request, storing the provisioning state information, and then sending the provisioning state information with a subsequent provisioning request.

16. A computer system comprising:
server hardware including a logical processor and a memory in operable communication with the logical processor;
a collection of digital identity information cards configuring a portion of the memory and having associated version indication(s);
provisioning software configuring a portion of the memory, the provisioning software embodying code to perform at least the following steps:
automatically receive a provisioning request for digital identity information cards; and
automatically identify within the collection any digital identity information cards which satisfy filtering parameter(s) associated with digital identity information card field(s);
and
provisioning state information indicating a client and a set of the client's digital identity information cards.

17. The system of claim 16, wherein the system further comprises a provisioning response containing at least one digital identity information card which satisfies at least one of the following filtering parameters: an identification of an issuer of information cards, an organizational role of a natural person, an account number of a natural person.

18. The system of claim 16, wherein the system further comprises a client configured with software embodying code to perform at least the following steps:
automatically track origin location of digital identity information cards received at the client;
automatically compare a first set of digital identity information card(s) which were received from a particular origin location and which satisfy certain filtering parameter(s) to a second set of digital identity information card(s) which were received from the same origin location and which satisfy the same filtering parameter(s);
automatically identify digital identity information card(s) which belong to the first set but not the second set, and
automatically discard each digital identity information card which belongs to the first set but not the second set.

19. The system of claim 16, wherein the system further comprises a proxy configured with a client-proxy provisioning request for digital identity information cards.

20. The system of claim 19, wherein the server hardware is inside a firewall, the client is outside the firewall, and the server memory is also configured with a client authorization basis for authenticating the client to the proxy and with a proxy authorization basis for authenticating the proxy to the server.
